(19) United States
(12) Patent Application Publication
(10) Pub. No.: US 2024/0176638 A1
(43) Pub. Date: May 30, 2024

(54) REGISTER PROTECTION FOR CONFIDENTIAL COMPUTING ENVIRONMENT

(71) Applicant: ADVANCED MICRO DEVICES, INC., Santa Clara, CA (US)

(72) Inventors: David Kaplan, Austin, TX (US); Jelena Ilic, Austin, TX (US); Jeremy W. Powell, Austin, TX (US)

(21) Appl. No.: 18/071,049

(22) Filed: Nov. 29, 2022

(51) Int. Cl. G06F 9/455; G06F 21/60

(52) U.S. Cl. CPC G06F 9/45558; G06F 21/602; G06F 2009/45583; G06F 2009/45587

(57) ABSTRACT

A processing system executing a virtual machine (VM) in a confidential computing environment selectively randomizes the values of registers before the register values are encrypted to ciphertext and written to a secure region of memory upon the VM exiting execution at a processor of the processing system. When the VM later resumes executing at the processor, the processor de-randomizes the register values. By randomizing the register values, the processor obfuscates the register values from a hypervisor or physical attack, thereby protecting against side channel attacks on the encrypted ciphertext.

### BACKGROUND

In a confidential computing environment, a processing system (e.g., a server) executes multiple software programs, such as virtual machines (also referred to herein as VMs or guests or guest VMs) and a virtual machine manager (e.g., a hypervisor), wherein different software programs are owned by different entities. For example, in some confidential computing environments, different virtual machines executed by the environment are owned by different companies. Implementation of such an environment can present security issues, such as exposing the data or operations of one virtual machine, owned by one entity, to another virtual machine, owned by a different entity.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that selectively randomizes guest registers when stored in a secure region of memory in accordance with some embodiments.

FIG. 2 is a block diagram illustrating an example of the processing system of FIG. 1 selectively randomizing guest registers of a virtual machine in response to the virtual machine stopping execution in accordance with some embodiments.

FIG. 3 is a block diagram illustrating an example of the processing system of FIG. 1 restoring values of guest registers of a virtual machine in response to the virtual machine resuming execution in accordance with some embodiments.

FIG. 4 is a block diagram illustrating hashing of guest register values with a nonce value in accordance with some embodiments.

FIG. 5 is a flow diagram illustrating a method for randomizing values of guest registers of a virtual machine in response to the virtual machine stopping execution in accordance with some embodiments

FIG. 6 is a flow diagram illustrating a method for restoring values of guest registers of a virtual machine in response to the virtual machine resuming execution in accordance with some embodiments.

### DETAILED DESCRIPTION

Even in a secure computing environment, in which the values of data stored at guest registers within a secure region of memory of a confidential computing environment are encrypted prior to storage, the data can be vulnerable to side-channel attacks. Typically, when a virtual machine (VM) stops executing at a processor of a processing system implementing a confidential computing environment (i.e., when the VM exits), the register state for the VM is stored to the secure region of memory, which is encrypted with a key that is unique to the VM. When the hypervisor of the processing system reads the memory or register state, the hypervisor only sees the encrypted ciphertext. The processing system performs encryption at a granularity of a block size (e.g., 16B blocks), and consequently, any change to the block input value changes the corresponding block ciphertext. The hypervisor or a physical attacker can leverage the ciphertext visibility at the block level to launch a side-channel attack.

For example, when a VM exits, the processing system encrypts the values saved at the guest registers allocated to the VM and writes the encrypted values to the secure region of memory. Although the hypervisor does not have access to the unencrypted register values, the hypervisor is able to read the encrypted ciphertext stored at the secure region of memory. If a malicious hypervisor frequently interrupts the VM and observes state changes in the secure region of memory, the hypervisor may infer information about the VM's activities. For example, if at a point in time the hypervisor detects a pattern in the ciphertext stored at the secure region of memory allocated to a VM and subsequently detects the same pattern of ciphertext, the hypervisor can infer that the register values did not change.

Alternatively, by determining known plaintext/ciphertext mappings, the hypervisor may target specific code sequences. For example, if the hypervisor sends a value of 0 and the VM stores the value at a register (RAX) of the secure region of memory allocated to the VM, the hypervisor could interrupt the VM and see what value RAX=0 has in ciphertext. Similarly, if the hypervisor sends a value of 1 and the VM stores the encrypted value at the secure region of memory, the hypervisor can interrupt the VM and see what value RAX=1 has in ciphertext. Subsequently, if the hypervisor sees a ciphertext value in the secure region of memory allocated to the VM that matches the RAX=0 or RAX=1 ciphertext value, the hypervisor will know that the value stored at the secure region of memory is 0 or 1.

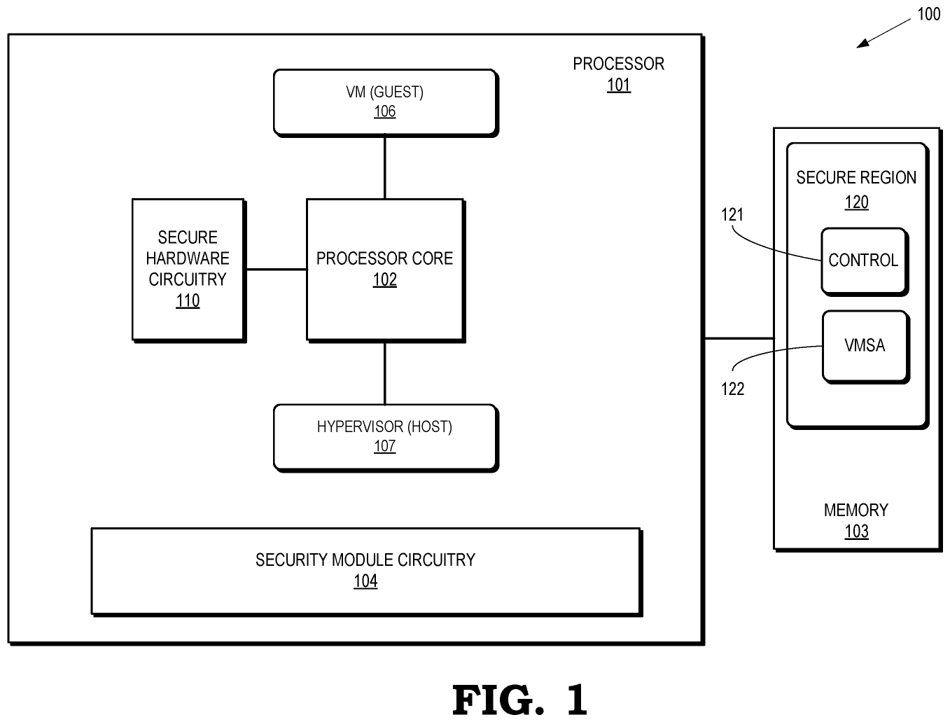

FIGS. 1-6 illustrate techniques for selectively randomizing the values of registers associated with a VM before the register values are encrypted to ciphertext and written to the secure region of memory upon the VM exiting execution at a processor of a processing system implementing a confidential computing environment. When the VM later resumes executing at the processor, the processor de-randomizes the register values. By randomizing the register values, the processor obfuscates the register values from the hypervisor or other guest VMs, thereby protecting against side-channel attacks on the encrypted ciphertext.

To illustrate, in some embodiments a processor executing a guest VM randomizes the values of registers associated with the guest VM before the register values are encrypted and stored to the secure region of memory allocated to the guest VM in response to the guest VM exiting. The processor creates a nonce value in response to each instance of the VM exiting execution at the processor. In some embodiments, the nonce value is created with a pseudo-random function at each VM exit. In other embodiments, the processor creates the nonce value with a random number generator. The processor performs a hash function of the nonce value with each value of a subset of registers allocated to the guest VM before the register values are encrypted and stored to the secure region of memory. The processor then encrypts the nonce value and stores the encrypted nonce value at the secure region of memory. In some embodiments, the hash function is a bit-wise XOR operation between the register value and the nonce value. Rather than encrypting and writing the register values to the secure region of memory, the processor encrypts and writes the result of the hash function (e.g., XOR operation) to the secure region of memory. Because a new nonce value is generated at each VM exit, the value of each register written to the secure region of memory changes every time the VM exits. Consequently, the values stored at the secure region of memory will appear to change at each VM exit, regardless of whether the corresponding register value was changed.

When the guest VM resumes execution at the processor, the processor reads the encrypted nonce value from the location at the secure region of memory and decrypts the nonce value. The processor reads and decrypts the values the VM guest registers and again performs a hash function (e.g., an XOR operation) with the nonce value to recover the original VM guest register values. By hashing the values written by the guest VM with a nonce value before encrypting and storing the values to the secure region of memory, the processor effectively hides the registers while the register values are stored in the secure region of memory. Obfuscating the registers not only protects against side-channel attacks by the hypervisor but also mitigates against physical attacks on the processing system. If an attacker is observing traffic being written to the secure region of memory while the processing system is executing VMs but all the register values change at every VM exit, the attacker will be unable to glean information about the guest VM's activities. Further, because there is no correlation between the ciphertext and the nonce value, the nonce value cannot be discovered.

In some embodiments, enablement of randomization of guest VM registers is controlled by the guest VM. The processing system notifies the guest VM that VM guest registers are randomizable, and the guest VM indicates whether to enable guest VM register randomization. In some embodiments, the processing system does not randomize every register allocated to the guest VM, but instead randomizes only a subset of the guest VM registers. For example, in some embodiments, the processing system randomizes general purpose registers and floating-point registers allocated to the guest VM, but does not randomize control registers allocated to the guest VM. In some embodiments, the processing system communicates to the guest VM via an interface which registers in the secure region of memory are randomizable. Software executing at the guest VM can then parse the secure region of memory to determine the register values.

FIG. 1 illustrates a processing system 100 that selectively randomizes guest registers when stored at a secure memory area allocated to the guest in accordance with some embodiments. The processing system 100 is generally configured to execute sets of instructions (e.g., computer programs) to carry out tasks on behalf of an electronic device. Accordingly, in different embodiments the processing system 100 is part of any of a variety of electronic devices. For purposes of description, it is assumed that the processing system 100 is part of an electronic device that implements a confidential computing environment, such as a server. However, in other embodiments, the processing system 100 is part of a desktop computer, laptop computer, tablet, game console, and the like.

To implement the confidential computing environment, and to execute the sets of instructions, the processing system 100 includes a processor 101 and a memory 103. In some embodiments, the processor 101 is a general-purpose processor, such as a central processing unit (CPU) including hardware structures configured to retrieve and execute the sets of instructions. The memory 103 includes one or more memory devices configured to store and retrieve data based on commands (e.g., store and load commands) received from the processor 101. Accordingly, in different embodiments the memory 103 is random access memory (RAM), non-volatile memory (NVM), hard disc memory, and the like, or any combination thereof.

To execute the sets of instructions, the processor 101 includes a processor core 102, a security module circuitry 104, and secure hardware circuitry 110. It will be appreciated that in some embodiments the processor 101 includes additional hardware to execute instructions, and to execute operations based on those instructions, such as additional processor cores, additional processing units (e.g., one or more graphics processing units), one or more controllers (e.g., memory controllers and input/output controllers), and the like.

The processor core 102 includes one or more instruction pipelines including a plurality of stages to execute instructions in a pipelined fashion. Thus, for example, in some embodiments an instruction pipeline of the processor core 102 includes a fetch stage, a decode stage, a dispatch stage, one or more execution stages (with one or more corresponding execution units), a retire stage, and the like. The processor core 102 also includes, or has access to, memory structures and other hardware (not explicitly illustrated at FIG. 1) that support execution of instructions. For example, in some embodiments the processor core 102 includes or has access to one or more cache structures to store data used for execution of the instructions.

The security module circuitry 104 is a set of hardware structures generally configured to create, monitor and maintain a security environment for the processor 101. For example, in at least some embodiments the security module circuitry 104 is configured to manage the boot process for the processor 101, initialize security-related mechanisms for the processor 101, and monitor the processing system 100 for suspicious activity or events and implement an appropriate response. In some embodiments the security module circuitry 104 includes a microcontroller, a cryptographic coprocessor (CCP) to encrypt and decrypt data, local memory and local registers to store, for example, cryptographic keys, and includes interfaces to interact with the memory 103, the I/O controller of the processor 101, and configuration registers of the processor 101. In some embodiments, the security module circuitry 104 includes Environment Management Control hardware that performs environmental and security checking to ensure that the processor 101 is operating according to specified security parameters.

The secure hardware circuitry 110 includes hardware, and associated microcode, of the processor 101 that supports the processor core 102 in executing instructions but is not accessible or modifiable by software executing at the processor core 102. For example, in some embodiments the secure hardware circuitry 110 includes hardware that implements finite state machines, hardwired control unit operations, and other hardware that carries out at least some operations generated by the processor core 102, based on the executing instructions. However, the operations of the secure hardware circuitry 110 are not accessible or modifiable by the executing software, the secure hardware circuitry 110 is able to provide security features in the course of executing operations as described further herein, and without those features being subject to unauthorized modification. For example, the secure hardware circuitry 110 is able to protect against side-channel attacks by obfuscating the values of certain registers before the register values are written to a secure region 120 of memory 103, as described further herein.

As noted above, the processing system 100 is generally configured to implement a confidential computing environment, and in particular to execute a plurality of virtual machines (VMs) (e.g., VM 106), also referred to as guests, and a hypervisor 107, also referred to as a host, to manage execution of the plurality of VMs. Because the different VMs, and at least in some cases the hypervisor 107, are owned by different entities, the processing system 100 implements security features to protect the data of a given VM from access by other software, such as by another VM or by the hypervisor 107. For example, the processing system 100 implements data security for the VMs by implementing the secure region 120 of the memory 103 that stores encrypted data. In particular, the processor 101 is configured to encrypt specified data for each VM according to a corresponding private cryptographic key, and to store the encrypted data at the secure region 120. Because the data is encrypted, the data for one VM is protected from unauthorized access by other VMs and by the hypervisor 107. In at least some embodiments, cryptographic keys for the VMs are managed by the security module circuitry 104, and data encryption and decryption for the VMs is executed by a dedicated hardware encryption/decryption module (not shown) at a memory controller (not shown) of the processor 101.

To further illustrate via an example, in the depicted embodiment the secure region 120 stores two blocks of data for the VM 106: control information 121 and a virtual machine storage area (VMSA) 122. The control information 121 stores control information for the VM 106, while the VMSA stores data for the software programs executed by the VM 106. Typically, in response to a request to store information by the VM 106 (e.g., in response to a VM exit), the processor 101 encrypts the information, using the cryptographic key associated with the VM 106, and stores the information at the corresponding block (either the control information 121 or the VMSA 122). Similarly, in response to a request to retrieve information from the secure region 120 by the VM 106, the processor 101 retrieves the requested information from the corresponding block, decrypts the information using the cryptographic key associated with the VM 106, and provides the decrypted information to the VM 106.

To protect against side-channel attacks, the processor 101 is configured to further protect data stored at the VMSA 122 by obfuscating the values of certain registers before the register values are written to the VMSA 122 in response to the VM 106 exiting. For example, in some embodiments the processor core 102 indicates to the VM 106 that register randomization is supported. In response, the VM 106 signals to the processor core 102 whether the VM 106 opts to have its register values randomized before being written to the secure region 120. If the VM 106 opts to have its register values randomized, the secure hardware circuitry 110 generates a nonce value (not shown) in response to an exit by the VM 106. In some embodiments, the secure hardware circuitry 110 generates the nonce value using a pseudo-random function. In other embodiments, the secure hardware circuitry 110 generates the nonce value using a random number generator.

The secure hardware circuitry 110 then performs a hash function of the nonce value and the values stored in at least a subset of registers allocated to the VM 106. For example, in some embodiments, the secure hardware circuitry 110 performs a bit-wise XOR operation between the nonce value and the values stored at the subset of registers. The subset of registers includes general purpose registers and floating-point registers allocated to the VM 106 in some embodiments. The processor 101 encrypts the result of the XOR operation using the cryptographic key associated with the VM 106 and stores the information at the VMSA 122 block for the VM 106. The processor 101 then encrypts and stores the nonce value at a location within the VMSA 122 block for the VM 106, at the secure region 120 of the memory 103.

In response to a subsequent request to execute the VM 106 (e.g., in response to the hypervisor 107 issuing a VMRUN command for the VM 106), the processor 101 reads and decrypts the nonce value from the location within the VMSA 122 block for the VM 106 and reads and decrypts the hashed subset of register values from the location within the VMSA 122 block for the VM 106. The processor 101 performs a hash function (e.g., performs a bit-wise XOR operation) between the nonce value and the subset of register values to retrieve the original values of the subset of register values.

The secure hardware circuitry 110 generates a new nonce value in response to each instance of a VM exit. In some embodiments, the secure hardware circuitry 110 updates the nonce value in a pseudo-random manner in response to each instance of a VM exit. By hashing the register values with the nonce value prior to encrypting and storing the register values, the processor 101 obscures the identities of the registers to which the VM 106 writes information and obscures the ciphertext from a selective plaintext recovery attack.

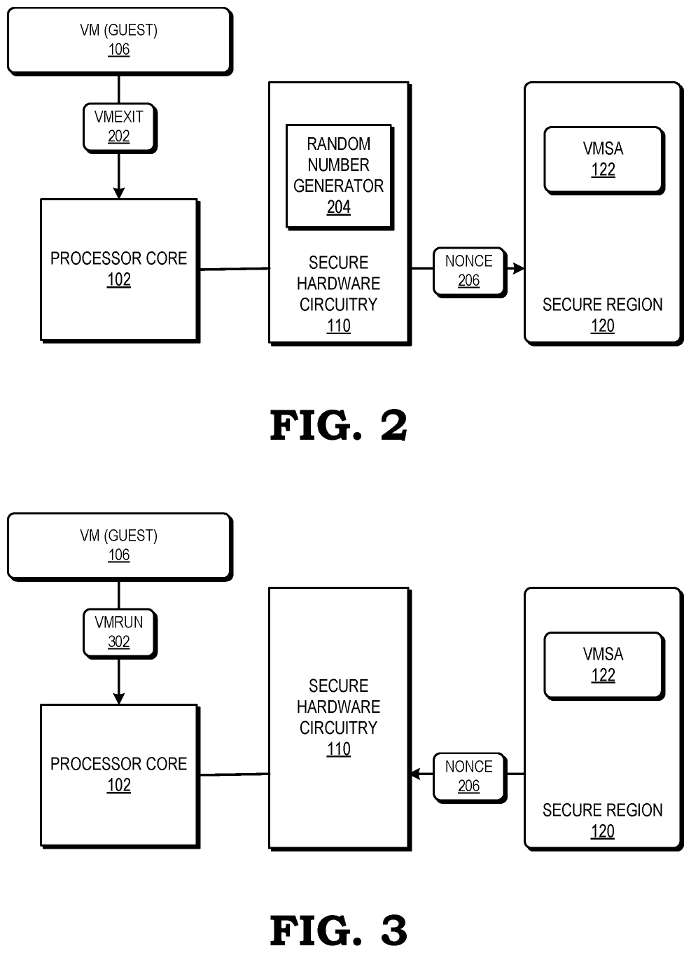

FIG. 2 illustrates an example of the processing system 100 of FIG. 1 selectively randomizing guest registers of a virtual machine in response to the virtual machine stopping execution (i.e., exiting) in accordance with some embodiments. In the illustrated example, the processor core 102 receives a VMEXIT command 202 indicating a request from the VM 106 to stop executing at the processor core. It will be appreciated that the VMEXIT command 202 is illustrated at FIG. 2 as being connected to the VM 106 to show that the VMEXIT command 202 is a request to stop executing the VM 106, but in at least some embodiments the VMEXIT command 202 itself is issued by the hypervisor 107.

In response to the processor core 102 receiving the VMEXIT command 202, the secure hardware circuitry 110 generates a nonce value 206. In the illustrated example, the secure hardware circuitry 110 includes a random number generator 204 that generates the nonce value 206. In other embodiments, the secure hardware circuitry 110 generates the nonce value using a pseudo-random function.

The secure hardware circuitry 110 performs a hash function such as a bit-wise XOR operation between the nonce value 206 and the values stored in at least a subset of registers written by the VM 106. In some embodiments, the subset of registers includes general purpose registers and floating-point registers. The secure hardware circuitry 110 notifies the VM 106 of which registers are included in the subset in some embodiments. Software executing at the VM 106 can use the information regarding which registers are included in the subset to allocate registers in the VMSA 122 block for the VM 106. The secure hardware circuitry 110 encrypts the results of the hash function and stores the encrypted results at the VMSA 122 block for the VM 106 at the secure region 120 of the memory 103. The secure hardware circuitry 110 then encrypts the nonce value and stores the encrypted nonce value to the VMSA 122 block for the VM 106. The results of the hash function obscure the plaintext/ciphertext correlation between unencrypted and encrypted values of the registers and also obscure which registers store values that have changed since a previous VMEXIT. Thus, a malicious hypervisor 107 or physical attacker will be unable to observe any patterns from which they could infer information about the activities of the VM 106.

FIG. 3 illustrates an example of the processing system 100 of FIG. 1 restoring values of guest registers of the VM 106 in response to the VM 106 resuming execution at the processor core 102 in accordance with some embodiments. In the illustrated example, the processor core 102 receives a VMRUN command 302 indicating a request to execute the VM 106. It will be appreciated that the VMRUN command 302 is illustrated at FIG. 3 as being connected to the VM 106 to show that the VMRUN command 302 is a request to execute the VM 106, but in at least some embodiments the VMRUN command 302 itself is issued by the hypervisor 107.

In response to the processor core 102 receiving the VMRUN command 302, the secure hardware circuitry 110 reads the encrypted nonce value 206 from the VMSA 122 block for the VM 106 and decrypts the nonce value 206. The secure hardware circuitry 110 then reads the hashed register values from the VMSA 122 block for the VM 106 and decrypts the hashed register values. The secure hardware circuitry 110 performs a hash function such as a bit-wise XOR operation between the nonce value 206 and the hashed register values. By performing the hash function, the secure hardware circuitry 110 recovers the original values written by the VM 106.

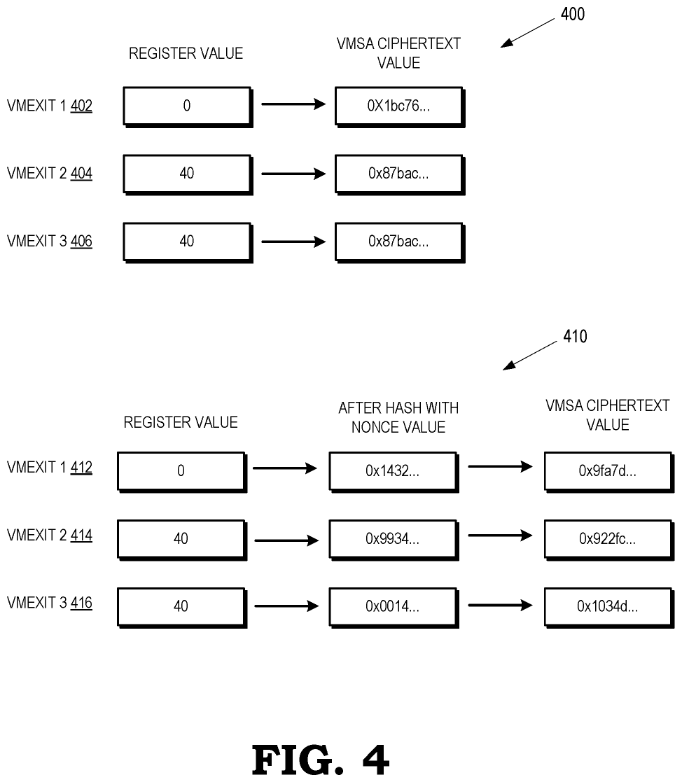

FIG. 4 is a block diagram illustrating hashing of guest register values with a nonce value in accordance with some embodiments. In an example 400, the secure hardware circuitry 110 encrypts register values written by the VM 106 to ciphertext without hashing. In the illustrated example, at VMEXIT 1 402, a register value of 0 is encrypted to a ciphertext value of 0x1bc76 . . . for storage at the VMSA 122. At VMEXIT 2 404, a register value of 40 is encrypted to a ciphertext value of 0x87bac . . . for storage at the VMSA 122. At VMEXIT 3 406, a register value of 40 is encrypted to a ciphertext value of 0x87bac . . . for storage at the VMSA 122. Thus, the hypervisor 107 or a physical attacker could determine from the ciphertext values stored at the VMSA 122 that the same value was written at VMEXIT 2 404 and VMEXIT 3 406.

In an example 410, the secure hardware circuitry 110 hashes register values with a nonce value before encrypting and storing the result at the VMSA 122. In the illustrated example, at VMEXIT 1 412, the VM106 writes a register value 0. The secure hardware circuitry 110 hashes the register value 0 with the nonce value 206, for example, by performing a bit-wise XOR operation, to obtain a hashed value 0x1432 . . . . The secure hardware circuitry 110 encrypts the result of the hash to a ciphertext value of 0x9fa7d . . . for storage at the VMSA 122. At VMEXIT 2 414, the VM 106 writes a register value 40. The secure hardware circuitry 110 hashes the register value 40 with the nonce value 206 to obtain a hashed value 0x9934 . . . . The secure hardware circuitry 110 encrypts the result of the hash to a ciphertext value of 0x922fc . . . for storage at the VMSA 122. At VMEXIT 3 416, the VM 106 again writes a register value 40. The secure hardware circuitry 110 hashes the register value 40 with the nonce value 206 to obtain a hashed value 0x0014 . . . . The secure hardware circuitry 110 encrypts the result of the hash to a ciphertext value of 0x1034d . . . for storage at the VMSA 122. Although the VM 106 wrote the same value (40) to the register at both VMEXIT 2 414 and VMEXIT 3 416, the ciphertext values written to the VMSA 122 block for the VM 106 are different and no pattern is discernible by a malicious hypervisor 107 or physical attacker.

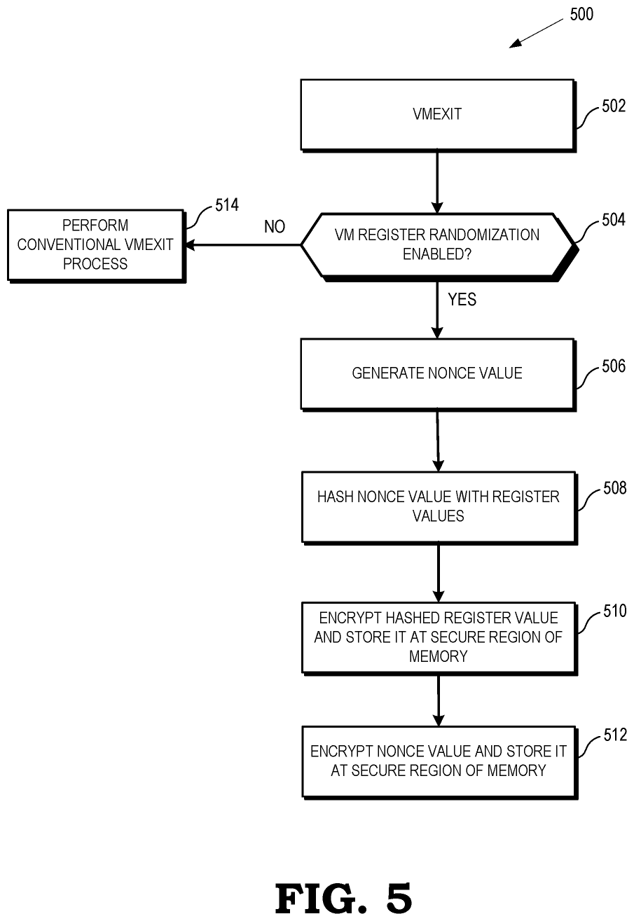

FIG. 5 is a flow diagram illustrating a method 500 for randomizing values of guest registers of a virtual machine in response to the virtual machine stopping execution in accordance with some embodiments. For purposes of description, the method 500 is described with respect to an example implementation at the processing system 100 of FIG. 1, but it will be appreciated that in other embodiments the method 600 is implemented at a server or other processing system that differs in some respects from the processing system of FIG. 1.

At block 502, the processor core 102 receives a request (e.g., a VMEXIT command 202) to stop executing (i.e., exit) the VM 106. At block 504, the processor 101 determines if VM register randomization is enabled by the VM 106. For example, in some embodiments, an enable bit is stored in the control information 121. The processor 101 initiates randomization of VM registers in response to receiving an indication from the VM 106 to selectively randomize the registers to which the VM 106 writes. If, at block 504, the processor 101 determines that VM register randomization is not enabled by the VM 106 (e.g., if the enable bit is not set), the method flow continues to block 514. At block 514, the processor 101 performs a conventional VMEXIT process without randomizing a subset of registers.

If, at block 504, the processor 101 determines that the VM 106 enables selective randomization of registers, the method flow continues to block 506. In some embodiments, the processor 101 notifies the VM 106 which registers will be randomized. For example, in some embodiments the processor 101 randomizes a subset of registers allocated to the VM 106. The subset includes at least one of general purpose registers and floating point registers in some embodiments. In other embodiments, the VM 106 indicates a subset of registers to randomize, e.g., at the control information 121.

At block 506, the secure hardware circuitry 110 generates a nonce value, such as by using a pseudo-random function. At block 508, the secure hardware circuitry 110 hashes the nonce value with a subset of the register values written by the VM 106, for example, by performing a bit-wise XOR operation. At block 510, the secure hardware circuitry 110 encrypts the plaintext hashed register values (i.e., the result of the XOR operation) to ciphertext and stores the encrypted hashed register values at the VMSA 122 block for the VM 106 at the secure region 120 of the memory 103. At block 512, the secure hardware circuitry 110 encrypts and stores the nonce value at the VMSA 122 block for the VM 106 at the secure region 120 of the memory 103.

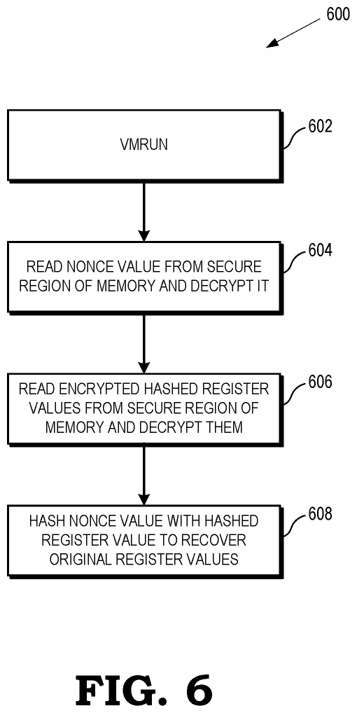

FIG. 6 is a flow diagram illustrating a method 600 for restoring values of guest registers of a virtual machine in response to the virtual machine resuming execution in accordance with some embodiments. For purposes of description, the method 500 is described with respect to an example implementation at the processing system 100 of FIG. 1, but it will be appreciated that in other embodiments the method 600 is implemented at a server or other processing system that differs in some respects from the processing system of FIG. 1.

At block 602, the processor core 102 receives a request (e.g., a VMRUN command 302) to execute the VM 106. In response to the request, at block 604, the secure hardware circuitry 110 reads the encrypted nonce value from the VMSA 122 block for the VM 106 at the secure region 120 of the memory 103 and decrypts the nonce value. At block 606, the secure hardware circuitry 110 reads and decrypts the encrypted hashed register values from the VMSA 122 block for the VM 106. At block 608, the secure hardware circuitry 110 hashes the nonce value with the hashed register values to recover the original register values.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to a virtual machine stopping execution at a processor, selectively randomizing a subset of values associated with the virtual machine;
encrypting the selectively randomized values; and
writing the encrypted selectively randomized values to registers at a secure region of memory allocated to the virtual machine.

2. The method of claim 1, wherein selectively randomizing comprises:
generating, at hardware circuitry of the processor, a nonce value comprising a pseudo-random or random value; and
hashing the nonce value with the values.

3. The method of claim 2, further comprising:
encrypting the nonce value; and
storing the encrypted nonce value at a location within the secure region of memory allocated to the virtual machine.

4. The method of claim 3, further comprising:
in response to the virtual machine resuming execution at the processor, reading the encrypted nonce value from the location;
decrypting the encrypted nonce value;
reading and decrypting the encrypted selectively randomized values from the registers; and
hashing the nonce value with the selectively randomized values.

5. The method of claim 1, further comprising:
selecting for randomization values written by the virtual machine to general purpose registers and floating-point registers.

6. The method of claim 1, wherein the values are guest register values associated with the virtual machine.

7. The method of claim 1, further comprising:
initiating selectively randomizing in response to receiving an indication from the virtual machine to selectively randomize.

8. A processor, comprising:
a processor core configured to execute a virtual machine; and
secure hardware circuitry configured to:
in response to a virtual machine stopping execution at the processor, selectively randomize values associated with the virtual machine;
encrypt the selectively randomized values; and
write the encrypted selectively randomized values to registers at a secure region of memory allocated to the virtual machine.

9. The processor of claim 8, wherein the secure hardware circuitry is configured to:
generate a nonce value comprising a pseudo-random or random value; and
perform a first hash function on the nonce value with the values.

10. The processor of claim 9, wherein the secure hardware circuitry is configured to:
encrypt the nonce value; and
store the encrypted nonce value at a location within the secure region of memory allocated to the virtual machine.

11. The processor of claim 10, wherein the secure hardware circuitry is configured to:
in response to the virtual machine resuming execution at the processor, read the encrypted nonce value from the location;
decrypt the encrypted nonce value;
read and decrypt the selectively randomized values from the registers; and
perform a second hash function on the nonce value with each result of the first hash function.

12. The processor of claim 8, wherein the secure hardware circuitry is configured to:
select for randomization values written by the virtual machine to general purpose registers and floating-point registers.

13. The processor of claim 8, wherein the values are guest register values associated with the virtual machine.

14. A system, comprising:
a processor configured to execute a virtual machine;
a memory; and
secure hardware circuitry configured to:
in response to the virtual machine stopping execution at the processor, selectively randomize values associated with the virtual machine;
encrypt the selectively randomized values; and
write the encrypted selectively randomized values to registers at a secure region of memory allocated to the virtual machine.

15. The system of claim 14, wherein selectively randomizing comprises:
generating, at the secure hardware circuitry, a nonce value comprising a pseudo-random or random number; and
hashing the nonce value with the values of information.

16. The system of claim 15, wherein the secure hardware circuitry is configured to:
encrypt the nonce value; and
store the encrypted nonce value at a location within the secure region of memory allocated to the virtual machine.

17. The system of claim 16, wherein the secure hardware circuitry is configured to:
in response to the virtual machine resuming execution at the processor, read the encrypted nonce value from the location;
decrypt the encrypted nonce value;
read and decrypt the encrypted selectively randomized values at the registers; and
hash the nonce value with the selectively randomized values.

18. The system of claim 14, wherein the secure hardware circuitry is configured to:
select for randomization values written by the virtual machine to general purpose registers and floating-point registers.

19. The system of claim 14, wherein the values are guest register values associated with the virtual machine.

20. The system of claim 14, wherein the secure hardware circuitry is configured to:
initiate selectively randomizing in response to receiving an indication from the virtual machine to selectively randomize.
